(19) United States
(12) Patent Application Publication
(10) Pub. No.: US 2014/0116613 A1
(43) Pub. Date: May 1, 2014

(54) Method of Forming Thermal Conductive Pillar in Metal Core Printed Circuit Board

(71) Applicant: COFAN USA, INC., Fremont, CA (US)

(72) Inventor: Chang Han, Pleasanton, CA (US)

(73) Assignee: Cofan USA, Inc., Fremont, CA (US)

(21) Appl. No.: 13/661,316

(22) Filed: Oct. 26, 2012

(51) Int. Cl. B05D 5/12; B32B 37/06; B23K 31/02; B32B 37/12

(52) U.S. Cl. 156/272.2; 427/97.4; 156/60; 156/330; 228/101

(57) ABSTRACT

A method of forming a thermal conductive pillar in a metal core printed circuit board comprises providing a substrate, depositing a dielectric layer on top surface of the substrate, depositing a conductive layer on top surface of the dielectric layer, forming a space in the metal core printed circuit board by selectively removing at least part of dielectric material from the dielectric layer, and depositing thermal conductive material in the space to form a thermal conductive pillar, wherein the thermal conductive pillar conducts heat generated by a device that is assembled with the metal core printed circuit board.

### TECHNICAL FIELD

The example embodiments of the present invention generally relate to metal core printed circuit board, and more particularly to method of forming thermal conductive pillar in metal core printed circuit board.

### BACKGROUND

The prevailing use of printed circuit boards integrated with power devices such as controllers and drivers, light emitting diode modules, power supplies and amplifiers drives to the use of a thermal management system while designing the printed circuit boards. A metal core printed circuit board uses a base metal to increase the thermal conductivity of the printed circuit board. FIG. 1A shows a metal core printed circuit board 100a of the prior art. As shown in FIG. 1A, the metal core printed circuit board 100a includes a thermal conductive metal substrate 102 and a dielectric layer 104 deposited on the substrate 102. Contact pads 106 electrically connect electrode pads (not shown) of a light emitting diode device (not shown). The dielectric layer 104 comprises dielectric material to prevent current leakage or short circuit between the substrate 102 and the contact pads 106. Since the dielectric layer 104 has low thermal conductivity, heat generated by power devices may not be dissipated efficiently that may result in overheating and damage to the power devices.

FIG. 1B illustrates a metal core printed circuit board 100b including an additional thermal conductive pad 108 of the prior art. When assembled, a light emitting diode may physically contact the metal core printed circuit board 100b via the thermal conductive pad 108 resulting in an acceleration of heat dissipation from the light emitting diode to the metal core printed circuit board. Since the dielectric layer 104 is still in the thermal dissipation path, the efficiency of thermal dissipation may be insufficiently.

FIG. 2 illustrates a light emitting diode 200 in a light emitting diode package (not numbered). A thermal conductive pad 208 is located below the light emitting diode package to conduct heat generated by the light emitting diode 200.

FIGS. 3A and 3B illustrate metal core printed circuit boards 300A and 300B assembled with light emitting diode device 200 illustrated in FIG. 2. As shown in FIGS. 3A and 3B, the light emitting diode devices contact either dielectric layer 304 of the metal core printed circuit board 300A, also shown in FIG. 1A, or thermal conductive pad 308 which is deposited on top of the metal core printed circuit board 300B, also shown in FIG. 1B.

### BRIEF SUMMARY

According to one exemplary embodiment of the present invention, a method of forming a thermal conductive pillar in a metal core printed circuit board comprises providing a substrate, depositing a dielectric layer on top surface of the substrate, depositing a conductive layer on top surface of the dielectric layer; forming a space in the metal core printed circuit board by selectively removing at least part of dielectric material from the dielectric layer and depositing thermal conductive material in the space to form a thermal conductive pillar. The thermal conductive pillar conducts heat generated by a device that is assembled with the metal core printed circuit board.

According to one exemplary embodiment of the present invention, a method of assembling a power device with a metal core printed circuit board. The metal core printed circuit board is formed by providing a substrate, depositing a dielectric layer on top surface of the substrate, depositing a conductive layer on top surface of the dielectric layer; forming a space in the metal core printed circuit board by selectively removing at least part of dielectric material from the dielectric layer and depositing thermal conductive material in the space to form a thermal conductive pillar. The thermal conductive pillar conducts heat generated by a device that is assembled with the metal core printed circuit board. The method of assembling a power device with the metal core printed circuit board comprises coupling electrode pads of the power device to contact pads of the metal core printed circuit board and coupling the thermal conductive pillar to the power device via a thermal conductive pad.

According to one exemplary embodiment of the present invention, a method of assembling a power device with a metal core printed circuit board. The metal core printed circuit board is formed by providing a substrate, depositing a dielectric layer on top surface of the substrate, depositing a conductive layer on top surface of the dielectric layer; forming a space in the metal core printed circuit board by selectively removing at least part of dielectric material from the dielectric layer and depositing thermal conductive material in the space to form a thermal conductive pillar. The thermal conductive pillar conducts heat generated by a device that is assembled with the metal core printed circuit board. The method of assembling a power device with the metal core printed circuit board comprises coupling electrode pads of the power device to contact pads of the metal core printed circuit board and coupling the thermal conductive pillar to the power device via a thermal conductive pad.

### BRIEF DESCRIPTION OF THE DRAWING(S)

Having thus described the example embodiments of the present invention in general terms, reference will now be made to the accompanying drawings, which are not necessarily drawn to scale, and wherein:

FIG. 1A shows a metal core printed circuit board of the prior art;

FIG. 1B illustrates a metal core printed circuit board including an additional thermal conductive pad of the prior art;

FIG. 2 illustrates a light emitting diode package with a thermal conductive pad located below the light emitting diode package;

FIGS. 3A and 3B illustrate metal core printed circuit boards assembled with a light emitting diode device;

FIGS. 4A-4C are cross-sectional views illustrating methods of forming a space in a metal core printed circuit board according to example embodiments of the present invention;

FIGS. 4D-4F are cross-sectional views illustrating methods of forming a thermal conductive pillar in the space that is formed in accordance with example embodiments illustrated by FIGS. 4A-4C according to example embodiments of the present invention;

FIG. 5 illustrates a metal core printed circuit board having a thermal conductive pillar assembled with a light emitting device; and

FIGS. 6A-6F and FIGS. 7A-7F are cross-sectional views illustrating methods of forming thermal conductive pillars according to example embodiments of the present invention.

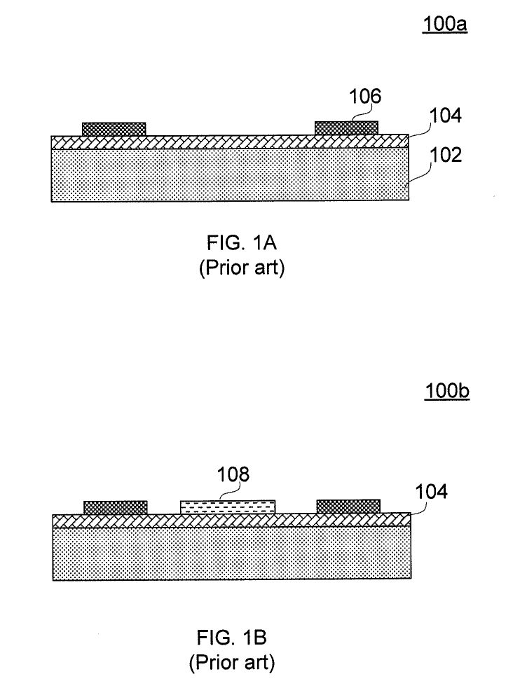

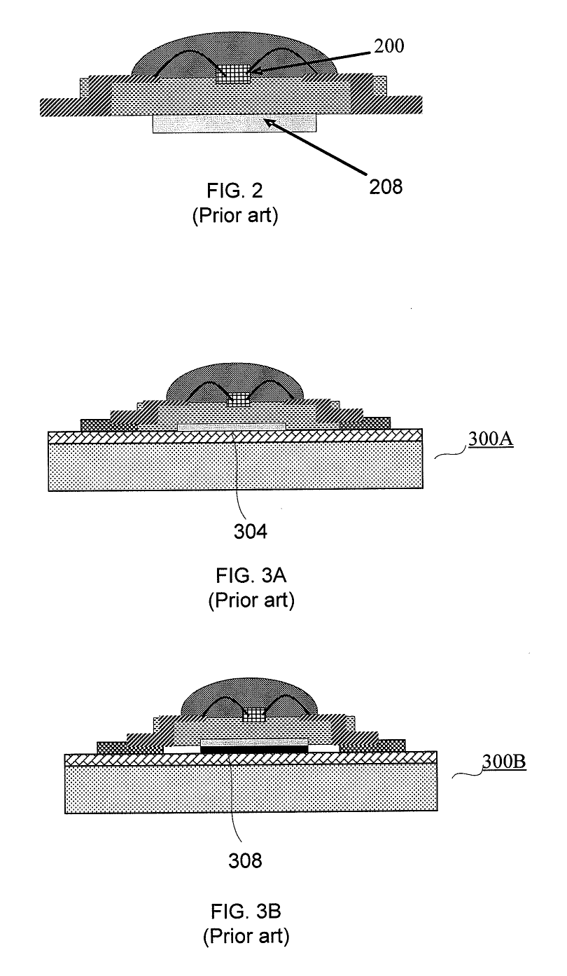

### DETAILED DESCRIPTION

The present disclosure now will be described more fully with reference to the accompanying drawings, in which some, but not all embodiments of the disclosure are shown. This disclosure may be embodied in many different forms and should not be construed as limited to the embodiments set forth; rather, these example embodiments are provided so that this disclosure will be thorough and complete, and will fully convey the scope of the disclosure to those skilled in the art. Like numbers refer to like elements throughout.

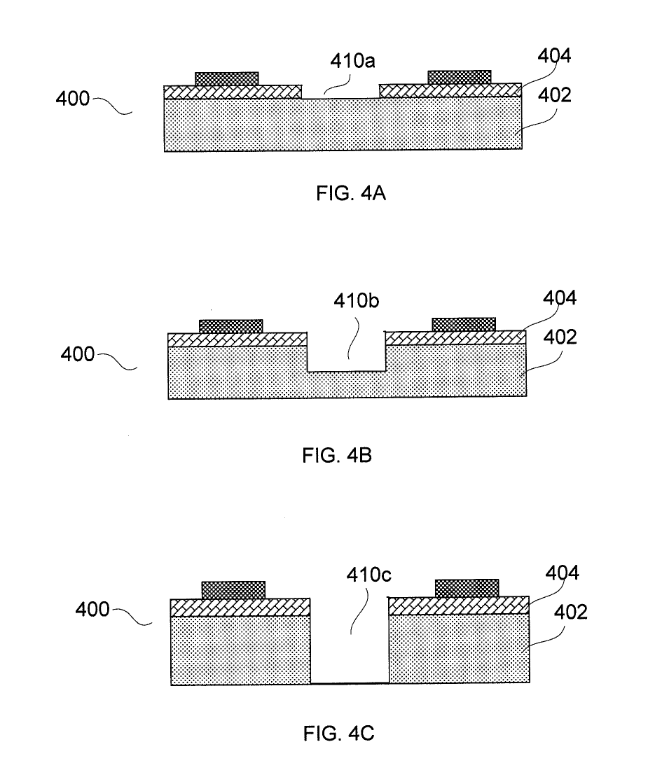

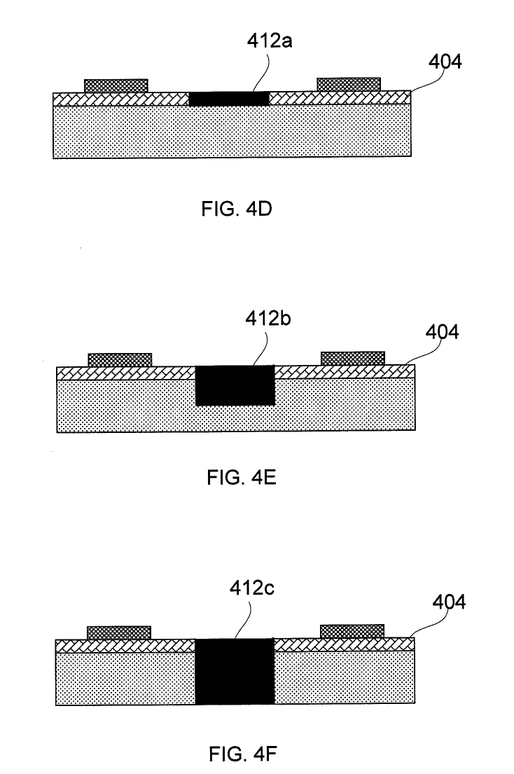

FIGS. 4A-4C are cross-sectional views to illustrate methods of forming a space in a metal core printed circuit board 400 according to example embodiments of the present invention. FIGS. 4D-4F are cross-sectional views to illustrate methods of forming thermal conductive pillar in the space formed in accordance with example embodiments illustrated by FIGS. 4A-4C according to example embodiments of the present invention. As shown in FIGS. 4A-4C, the method may include depositing a dielectric layer 404 on a substrate 402. The dielectric layer 404 may be deposited by dielectric film lamination, or other deposition methods such as physical vapor deposition (PVD), sputtering, pulse laser deposition, chemical vapor deposition (CVD), plasma-enhanced CVD, plating, chemical solution deposition, e-beam deposition or any other suitable methods. Part of the layer(s) previously deposited on the substrate 402 may be selectively removed by mechanical drilling or punching process or any other suitable processes to form a space in the metal core printed circuit board 400. As shown in FIG. 4A, part of the dielectric layer 404 may be selectively removed to expose part of the substrate 402 to form a space 410a. In another embodiment, part of the dielectric layer 404 and the substrate 402 may be selectively removed. The space may extend from top surface of the dielectric layer 404 into the substrate 402 to form a space 410b as shown in FIG. 4B. In another embodiment, the space may extend from top surface of the dielectric layer 404 to bottom surface of the substrate 410 to form a space 410c as shown in FIG. 4C. To form thermal conductive pillar in the space, such as the spaces 410a, 410b or 410c, thermal conductive material may be filled in the space. The thermal conductive material may be provided in liquid phase or may be converted from solid phase to liquid phase by heating or any other suitable methods. A post thermal treatment may be applied to the liquid phase thermal conductive material to form a solid thermal conductive pillar in the space. For instance, as shown in FIG. 4D, a thermal conductive pillar 412a may be formed in the space 410a. Similarly, FIGS. 4E and 4F illustrate a thermal conductive pillar 412b and 412c deposited in the space 410b and space 410c respectively. In the embodiments illustrated by FIGS. 4D-4F, surface of the thermal conductive pillar (412a, 412b, 412c) is in a planar surface with that of the dielectric layer 404. In some other embodiments, surface of the thermal conductive pillar (412a, 412b, 412c) may exceed that of the dielectric layer 404.

The substrate 402 may comprise at least one of a metal, such as aluminum, copper, gold, silver, tungsten, zirconium and zinc. The substrate may be an alloy, such as aluminum 2024, aluminum 5052, aluminum 6061, aluminum 7075, aluminum A356, brass yellow, brass red, copper alloy 11000, or a combination thereof. In some other example embodiments, the substrate 402 may comprise at least one of ceramic, such as aluminum nitride, silicon carbide, alumina and silicon nitride. The dielectric layer 404 may comprise at least one of plastic, glass, ceramic, Pre-Preg (glass fiber), fiber, carbon fiber/tube and clad. The conductive material may comprise at least one of Pb, Sn, Ag, Cu, In, Al, Zn, Sb, Cd and Bi.

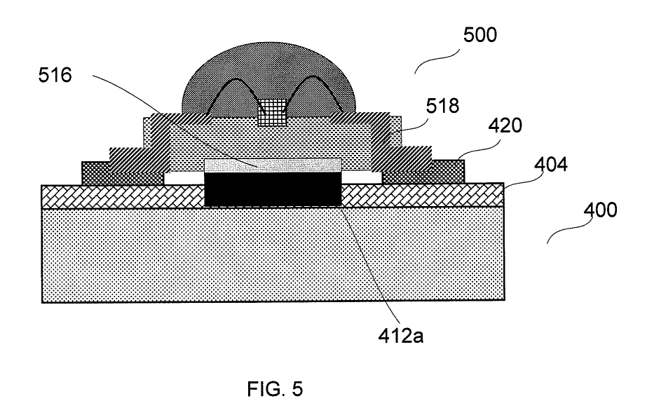

FIG. 5 illustrates a power device 500 assembled with the metal core printed circuit board 400 including the thermal conductive pillar 412a, as described in FIG. 4D. The power device may be a light emitting device or any other devices that may be assembled with metal core printed circuit board and may generate heat in operation. In this embodiment, surface of the thermal conductive pillar 412a may exceed that of the dielectric layer 404. Similar assembling methods may be applied to the metal core printed circuit boards illustrated in FIGS. 4B and 4E, and FIGS. 4C and 4F. In this embodiment, a thermal conductive pad 516 may be located below the power device 500. When assembled, electrode pads 518 of the power device 500 are respectively coupled to contact pads 420 of the metal core printed circuit board 400 by means of one of conductive bonders, conductive epoxy and solder paste using one of reflow process, thermal cure, ultrasonic and ultraviolet methods. After assembled, the thermal conductive pillar 412a physically contacts the thermal conductive pad 516 which may provide efficient path for heat dissipation of the metal core printed circuit board 400.

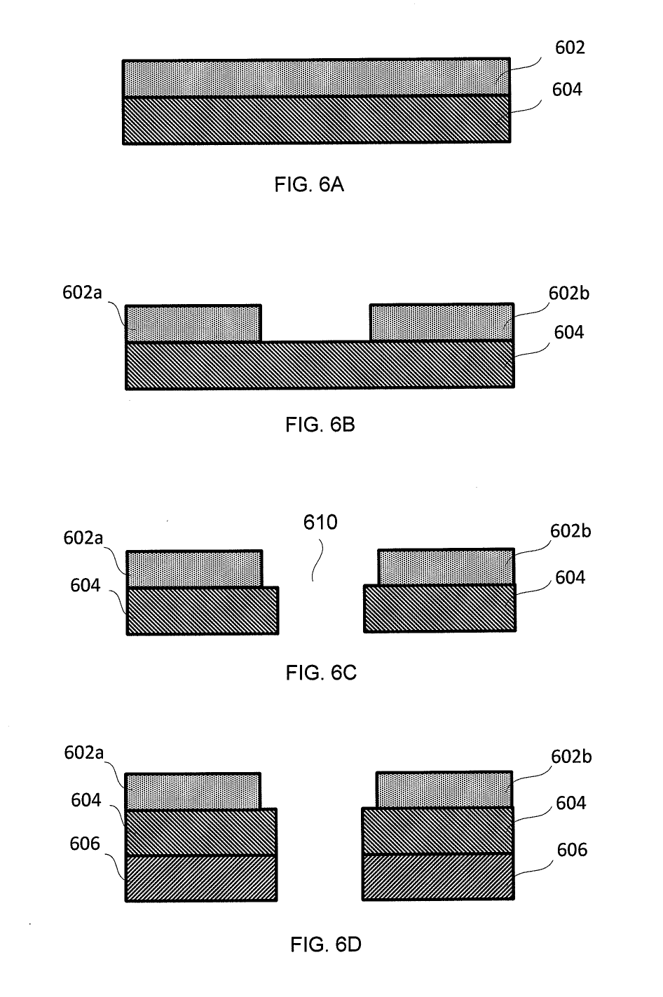

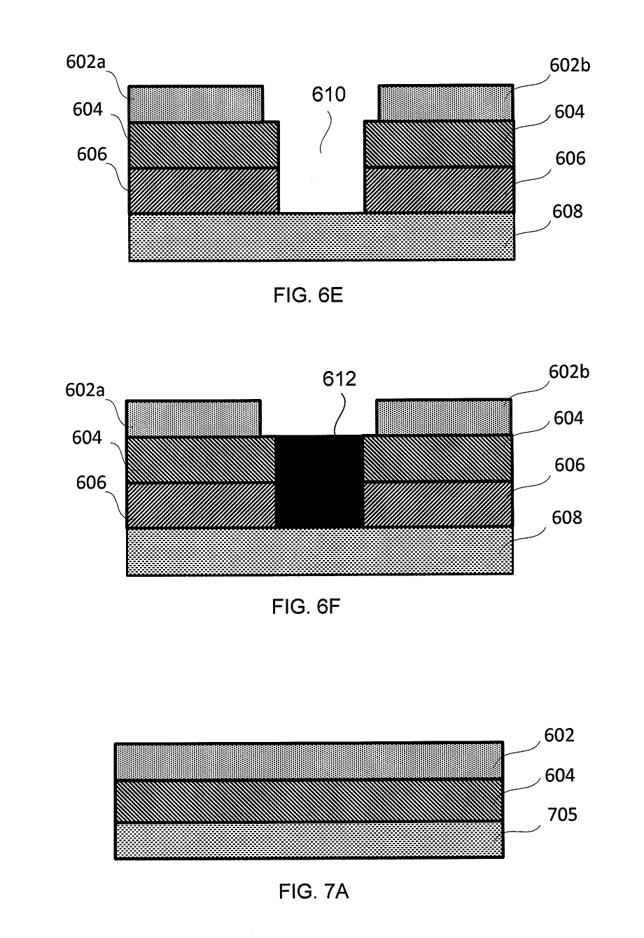

FIGS. 6A-6F are cross-sectional views to illustrate methods of forming a thermal conductive pillar according to one example embodiment of the present invention. The method may include depositing a conductive layer 602 on top surface of a dielectric layer 604 as shown in FIG. 6A. A film deposition method such as metal film lamination, physical vapor deposition (PVD), sputtering, pulse laser deposition, chemical vapor deposition (CVD), plasma-enhanced CVD, plating, chemical solution deposition, e-beam deposition or any other suitable methods may be used. A photolithograph process may then be applied to transfer a pattern on a photomask to a light-sensitive photoresistor. Conductive material of the conductive layer 602 may be selectively removed by dry, wet etching process or any other suitable processes to expose part of the dielectric layer 604 thereby forming first contact pads 602a and 602b, as shown in FIG. 6B. Referring to FIG. 6C, dielectric material may be selectively removed from the dielectric layer 604 to form a space 610 by etching mechanical drilling, punching process or any other suitable processes. The space 610 may extend through the dielectric layer 604. With reference to FIG. 6D, a dielectric adhesive layer 606 may be deposited on bottom surface of the dielectric layer 604. The previously deposited layers (602a, 602b, 604 and 606) are then deposed on top surface of a substrate 608 with the dielectric adhesive layer 606 in contact with the substrate 608, as shown in FIG. 6E. The space 610 therefore extends from the top surface of the dielectric layer 604 to the top surface of the substrate 608. Similar to the method described in FIG. 4D, liquid phase conductive material may be deposited in the space 610. A solid thermal conductive pillar 612 is then formed in the space 610, as shown in FIG. 6F. In this embodiment, surface of the solid thermal conductive pillar 612 is in a planar surface with that of the dielectric layer 604. In other embodiments, the surface of the solid thermal conductive pillar 612 may exceed that of the dielectric layer 604.

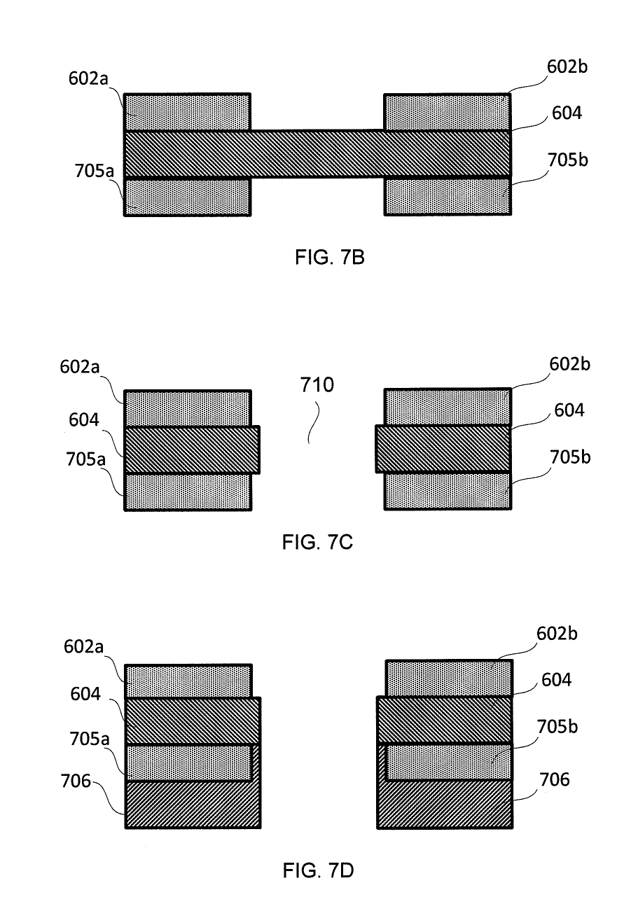

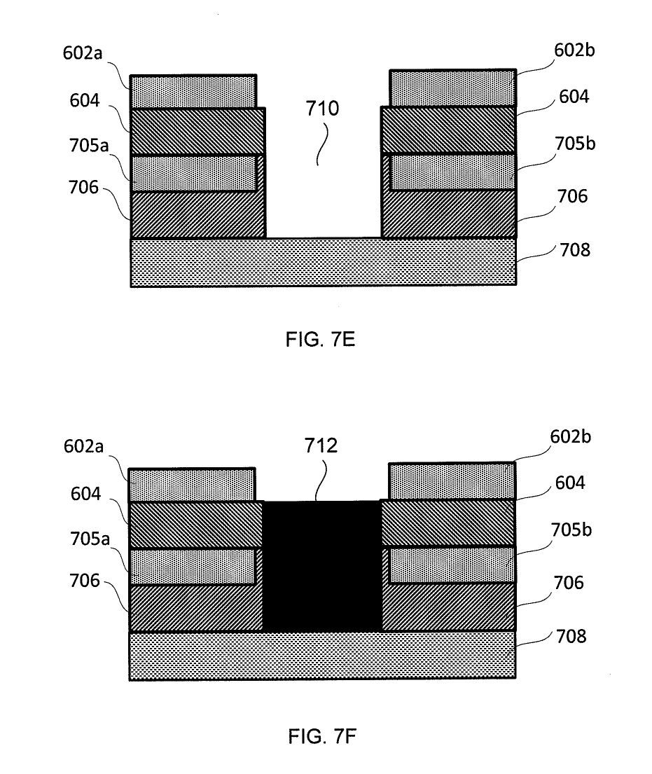

In another embodiment, prior to forming the space 610, another conductive layer 705 may be deposited on bottom surface of the dielectric layer 604, as shown in FIG. 7A. Similar to forming the contact pads 602a and 602b, conductive material of the conductive layer 705 may be selectively removed to expose part of bottom surface of the dielectric layer 604 by a photolithograph, etching process or any other suitable processes, resulting in second contact pads 705a and 705b on an opposite surface of the dielectric layer 604 as opposed to the surface on which the contact pads 602a and 602b are formed, as illustrated in FIG. 7B. Similar to FIG. 6C, dielectric material may be selectively removed from the exposed part of the dielectric layer 604 to form a space 710 (shown in FIG. 7C) by mechanical drilling, punching process or any other suitable processes. With reference to FIG. 7D, a dielectric adhesive layer 706 may then be deposited on the second contact pads 705a and 705b. The dielectric adhesive layer 706 may cover side surfaces of the contact pads 705a and 705b and/or the exposed part of the dielectric layer 604. The previously deposited layers (602a, 602b, 604, 705a, 705b and 706) are then deposed on a substrate 708 with bottom surface of the dielectric adhesive layer 706 in contact with the substrate 708, as shown in FIG. 7E. The space 710 may extend from the top surface of the dielectric layer 604 to the substrate 708. Similar to the method described in FIGS. 4D and 6F, liquid phase thermal conductive material may be deposited in the space 710. A solid thermal conductive pillar 712 in the space 710 (shown in FIG. 7F) is then formed. Similar to FIG. 6F, in this embodiment, surface of the solid thermal conductive pillar 712 is in a planar surface with that of the dielectric layer 604. In other embodiments, the surface of the solid thermal conductive pillar 712 may exceed that of the dielectric layer 604.

Many modifications and other example embodiments set forth herein will come to mind to one skilled in the art to which these example embodiments pertain to having the benefit of the teachings presented in the foregoing descriptions and the associated drawings. Therefore, it is to be understood that the embodiments are not to be limited to the specific ones disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

That which is claimed:

1. A method of forming a thermal conductive pillar in a metal core printed circuit board, comprising:
providing a substrate;
depositing a dielectric layer on top surface of the substrate;
depositing a conductive layer on top surface of the dielectric layer;
forming a space in the metal core printed circuit board by selectively removing at least part of dielectric material from the dielectric layer; and
depositing thermal conductive material in the space to form a thermal conductive pillar, wherein the thermal conductive pillar conducts heat generated by a device that is assembled with the metal core printed circuit board.

2. The method of claim 1, forming a space in the metal core printed circuit board further comprising selectively removing dielectric material from the dielectric layer to expose part of the substrate to form the space.

3. The method of claim 1, forming a space in the metal core printed circuit board further comprising selectively removing dielectric material from the dielectric layer and at least part of the substrate to form the space.

4. The method of claim 3, wherein the space extends through the dielectric layer into the substrate.

5. The method of claim 3, wherein the space extends from top surface of the dielectric layer to bottom surface of the substrate.

6. The method of claim 1, further comprising heating thermal conductive material to convert the thermal conductive material to liquid phase.

7. The method of claim 6, further comprising converting liquid phase thermal conductive material to solid phase thermal conductive pillar.

8. The method of claim 6, further comprising applying one of curing and reflow process to convert the liquid phase thermal conductive material to solid phase thermal conductive pillar.

9. The method of claim 1, wherein the conductive material may include at least one of Pb, Sn, Ag, Cu, In, Al, Zn, Sb, Cd and Bi.

10. A method of forming a thermal conductive pillar in a printed circuit board, the method comprising:
depositing a first conductive layer on top surface of a dielectric layer;
selectively removing conductive material of the first conductive layer to expose part of the top surface of the dielectric layer to form first contact pads;
forming a space by selectively removing at least part of dielectric material from the dielectric layer;
depositing a dielectric adhesive layer;
providing a substrate in contact with bottom surface of the dielectric adhesive layer, the space extending from the top surface of the dielectric layer to the substrate; and
depositing liquid-phase thermal conductive material in the space to form solid-phase thermal conductive pillar.

11. The method of claim 10, further comprising depositing the dielectric adhesive layer on bottom surface of the dielectric layer.

12. The method of claim 10, prior to forming the space, further comprising:
depositing a second conductive layer on bottom surface of the dielectric layer; and
selectively removing conductive material from the second conductive layer to expose part of the bottom surface of the dielectric layer to form second contact pads.

13. The method of claim 12, further comprising depositing the dielectric adhesive layer on surface of the second contact pads.

14. The method of claim 10, further comprising converting the liquid phase thermal conductive material to solid phase thermal conductive material.

15. A method of assembling a power device with the metal core printed circuit board of claim 1, the method comprising:
coupling electrode pads of the power device to contact pads of the metal core printed circuit board;
coupling the thermal conductive pillar to the power device via a thermal conductive pad.

16. The method of claim 15, wherein the electrode pads of the power device are electrically connected to the contact pads of the metal core printed circuit board by means of one of conductive bonders, conductive epoxy and solder paste.

17. The method of claim 15, wherein the electrode pads of the power device are coupled to the contact pads of the metal core printed circuit board using one of reflow solder, thermal cure, ultrasonic and ultraviolet methods.
